(19) United States
(12) Patent Application Publication
(10) Pub. No.: US 2002/0193031 A1
(43) Pub. Date: Dec. 19, 2002

(54) Laminates for blisters and pouches

(76) Inventor: David Thomas Stell, Bristol (GB)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 10/149,599

(22) PCT Filed: Dec. 19, 2000
(86) PCT No.: PCT/GB00/04897

(30) Foreign Application Priority Data
Dec. 22, 1999 (GB) 9930139.2

(51) Int. Cl. B32B 15/14

(52) U.S. Cl. 442/378

(57) ABSTRACT

Laminates consisting of a metal foil (2) having an uncoated surface which has been directly heat sealed to the surface (4) of a polymeric web (1) by an outer surface (4) of the web, the outer surface (4) of the web (1) consisting of a blend of an ethylene/vinyl acetate copolymer and an additive which embrittles the copolymer at room temperature. Packages produced by directly heat sealing metal foils (2), preferably aluminum foil, to polymeric webs (1) having the specified outer surface have exhibited peel strengths, for example in the range of from 2 to 6N/15 mm, which enable press through packages to be produced which do not peel open when tablets are pushed through them but will peel when in the form of pouches.

This invention concerns laminates, and in particular laminates of polymeric webs to metal foils, especially in the form of packages.

Blister packs used, for example, for the packaging of pharmaceuticals, typically consist of a thermoformed polymer web with a plurality of recesses into which individual tablets or capsules are placed before being sealed by a metal foil. The contents of the individual recesses can then be accessed by pushing them through the metal foil.

In order to facilitate adhesion of the metal foil, usually aluminum foil, to the thermoformed polymer web, the foil is usually pre-coated with an adhesive layer, for example by applying a solution of a styrene/acrylate copolymer in a solvent followed by evaporation of the solvent. The coated foil is then heat sealed to the polymer web using the copolymer as a laminating adhesive.

Packs in the form of pouches consisting of a polymeric web adhered to a metal foil are used, for example, for storing a variety of materials, e.g. blood bags. In this case, the metal foil, usually aluminum, is first extrusion coated with polyethylene to facilitate its subsequently being heat sealed to the polymer web using the polyethylene as a laminating adhesive.

Although metal foils can be heat sealed directly to polymer webs used hitherto for packaging purposes, such seals are often unsatisfactory for applications where seal integrity is important, for example medical uses. In general this results from relatively weak and unreliable adhesion between the metal surface and the polymer forming the outer surface of the web.

Hitherto, this problem has been overcome by the solvent coating and extrusion lamination processes described above. However, there still remains the desire to achieve adhesion of uncoated metal foils directly to polymeric webs to produce bonds which are sufficiently strong to provide satisfactory seal integrity for end uses such as the packaging of blood bags.

Laminates with peel strengths of less than 2N/15 mm are in general unsatisfactory either for press through packaging or for peel open pouches as they tend in the case of press through packaging to peel apart before rupturing of the foil occurs, thereby releasing more than one tablet, and indeed in the case of peel open pouches they may be insufficiently strong to prevent inadvertent peeling open of the pouches during transit. Despite this, different peel strengths will often be required for different end uses because some end uses positively require the seals to be openable by peeling, such as in the case of peel open pouches, whereas others do not, such as press through packaging.

In general, the peel strengths of metal foil/polymeric web laminates used for press through packaging need to be sufficient to prevent peeling rather than rupture of the metal foil when a packaged object is pushed through the foil. In this case the peel strength of concern is that for peeling the metal from the polymer web. However, in the case of peel open pouches, both peel strengths are of concern in order to maintain seal integrity during transit, whereas the peel strength for peeling the polymeric web from the metal foil is in general of importance in determining the ease of opening of peel open pouches when they need to be opened.

As will be appreciated by those skilled in the packaging art, the method of peeling of heat seals can affect the peel strength which is observed for them. More particularly, the peel strengths required to pull a polymeric web from a metal foil are often quite different from those required to peel for pulling the metal foil from the same polymeric web. Peel strengths specifically referred to herein are therefore for peeling polymeric webs from metal foils unless stated otherwise.

According to the present invention there is provided a laminate comprising a metal foil having an uncoated surface which has been directly heat sealed to the surface of a polymeric web by an outer surface of the web, said outer surface of the web comprising a blend of an ethylene/vinyl acetate copolymer and an additive which embrittles the said copolymer at room temperature.

Laminates in accordance with the present invention formed by heat sealing uncoated metal foils, preferably aluminum foil, directly to polymeric webs having the specified outer surface have exhibited peel strengths which enable press through packages to be produced which do not peel open when tablets are pushed through them but will peel when in the form of pouches, for example in the range of from 2 to 6N/15 mm. In general peel strengths of at least 2N/15 mm, and more preferably at least 3N/15 mm, are desirable for peel open packages in order to provide them with sufficient strength to avoid their inadvertent opening during transit. However, peel strengths of more than 5N/15 mm are generally undesirable for peel open packages formed from 10 μm thick aluminum foil, or more than 10N/15 mm for packages formed from 30 μm thick aluminum foil, in order to reduce the risk of tearing the metal foil during peeling. Tearing, of course, is desired for press through packages.

In general there is no preferred upper limit for the peel strengths of the seals used for press through packages because peeling is normally to be avoided so that when pressing a packaged object through the metal foil, adjacent articles are not released inadvertently with the object which is intended to be released. Although the peel strength of concern in this case is that of the metal foil from the polymer web, and such peel strengths often being numerically less than for peeling the same web from the metal foil, peel strengths of the web from the foil of at least 2N/15 mm are usually sufficient to prevent peeling when pressing an object through a 10 μm thick aluminum foil.

The outer surface which is adhered directly to the uncoated metal foil should be formed from a blend of an ethylene/vinyl acetate copolymer and an additive which embrittles the copolymer at room temperature.

The additive used to embrittle the outer surface of the polymer web which is adhered directly to the uncoated metal foil is preferably compatible with the polymer with which it is blended. The term “compatible” is used herein to indicate that the additive is not visible in the blend at a resolution of 1 μm in an optical microscope.

Examples of such additives for use with ethylene/vinyl acetate copolymers include poly-di-pentene, polyterpenes, α-methyl styrene resins, vinyltoluene/α-methyl styrene resins, modified aromatic resins and other low molecular weight resins, and in particular the hydrogenated and pure monomer hydrocarbon resins sold by Hercules Inc under the Trade Marks “Regalite”, “Kristalex”, “Piccotex”, “Hercures” and “Hercotac”.

The relative amounts of the copolymer and the embrittling additive forming the specified outer surface can be varied widely. However, either very small or very large amounts of the embrittling additive can result in an adverse effect on the strength of the heat seal of this surface to the metal foil.

The blends preferably contain at least 20 wt % and more preferably from 30 to 40 wt % of the additive.

Not only does the amount of embrittling additive present in the blends affect the peelability of the polymeric web from the metal foil, the relative amounts of ethylene and vinyl acetate in the copolymer also have an effect. Preferably the vinyl acetate content of the copolymer is at least 4.5 wt %, and more preferably at least 9 wt %, in order to provide adequate adhesion between the web and the metal foil. However, excessively high vinyl acetate contents can lead to excessively high peel strengths, for example for end uses where peeling is required such as with pouches. The vinyl acetate content is preferably less than 30 wt %.

The polymeric webs used to form laminates in accordance with the present invention preferably consists of one or more polymeric layers in addition to a layer which forms the outer surface to which the metal foil is adhered directly. The materials used to form such further layer or layers will in general be selected according to the intended end use of the laminate.

The peelability of laminates in accordance with the present invention can be modified by the use of polymeric webs which include at least one intermediate layer consisting of a blend of a polymeric material and a material which reduces internal cohesion within this layer. Peeling can then take place by breaking through the layer which adheres the polymeric web to the uncoated surface of the metal foil, and subsequently by rupturing the intermediate layer within its thickness through the thickness of the seal and eventually back through the surface layer. This is often accompanied by a change in the optical properties of the intermediate layer which can give rise to a tamper evident effect which can often be seen on both peeled surfaces.

Examples of polymers which can be used to form such intermediate layers include polyolefins and particularly polyethylene, for example low density polyethylene or linear low density polyethylene, and copolymers of propylene and ethylene. Additives which can be used with such polymers to reduce their internal cohesive strengths include incompatible polymers, that is polymers which induce phase separation within the intermediate layer, for example polyolefins, e.g. polybutene-l and linear low density polyethylene, and inorganic particulate materials, for example chalk, talc, titanium dioxide, barium sulfate and magnesium sulfate.

Although both sides of the metal foil used to form laminates in accordance with the present invention will often be uncoated, for example when the laminate is in the form of a press through package, the foil can form the outer surface of a laminate consisting of the foil with a polymeric web thereon. The use of such coatings is preferred when the puncture resistance of the metal foil is insufficient for particular end uses.

Polymeric webs used in accordance with the present invention preferably include at least one layer which has good moisture vapor and/or oxygen barrier properties in order to take advantage of the inherently good barrier properties to water vapor and oxygen exhibited by the metal foils and thereby provide sealed packages having such properties. Examples of polymers having such properties include nylons and ethylene/vinyl alcohol copolymers.

In one preferred embodiment of the present invention, the polymeric web has been thermoformed, for example for blister packaging articles, e.g. pharmaceutical products, and the uncoated metal foil has been heat sealed over the articles, directly on to outer surface of the web formed from the blend.

The polymeric web in this case preferably consists of an outer layer of the blend on one or more further and thermoformable polymeric layers, at least one of said further polymeric layers preferably having good barrier properties to water vapor and oxygen. Polypropylene and high density polyethylene in general have relatively good barrier properties but are difficult to thermoform. Other polyolefins have a greater degree of thermoformability and a relatively high barrier to water vapor but a relatively low barrier to oxygen, examples of such polymers including cyclic-olefin copolymers. Preferred cyclic-olefin copolymers for use in accordance with the present invention include copolymers of norbornene and ethylene.

In a second preferred embodiment of the present invention, the laminates are in the form of pouches in which the polymeric web is flexible and is heat sealed directly to an uncoated surface of a metal foil, the surface of the web which is heat sealed directly to the metal foil being formed by a layer of the blend which is itself on a base layer, for example of a polyolefin. More particularly, it is generally preferred that when a polyolefin is used for the base layer it should contain substantially none of the embrittling additive which is present in the surface layer which seals the web to the metal foil. The web can then be provided with the desired flexibility so that when the pouches are handled they will not rupture. The base layer is preferably formed from polyethylene.

Although polyolefins, for example polyethylene and poly-a-olefins such as polypropylene have relatively good moisture barrier properties, it is generally preferred that the polymeric web include a further polymeric layer to increase these barrier properties. A particularly preferred polymer for the purpose is polychlorotrifluroethylene.

The polymeric webs used to form laminates in accordance with the present invention will in general be of a thickness required to perform the function for which the laminates will be used. For example, thermoformable webs will usually be at least 100 μm thick. However, they will usually be not more than 500 μm thick. A preferred thickness for thermoformable webs is about 250 μm.

The various layers of thermoformable polymeric webs used in accordance with the invention can also be selected to achieve particular physical properties, for example strength and/or water vapor/oxygen barrier properties.

The surface formed from the blend of a polyolefin and an embrittling additive, and to which the metal foil is heat sealed, is preferably from 5 to 25 μm thick and more preferably about 10 μm thick. If this layer is too thin, the strength of the heat seal to the metal foil may be insufficient to maintain the integrity of the seal, for example when an attempt is made to push a packaged article through the foil, peeling may occur into a compartment of an adjacent article rather than the foil being ruptured.

If a further outer layer is present consisting of a polyolefin, this layer is preferably 20 to 200 μm thick, the thickness depending, for example, on the barrier properties required for the web.

The base layer will, in general, be thicker than the further outer layer in order to provide the web with adequate thermoformability, for example from 75 to 300 μm.

When the polymeric webs form part of a flexible pouch, they will in general be considerably thinner than webs used for thermoforming. For example, webs for forming pouches will usually be not more than 200 μm thick, and typically not more than 150 μm thick, in order to provide the desired degree of flexibility, although they will usually be at least 50 μm thick in order to provide sufficient strength to avoid accidental rupture during handling.

The relative thicknesses of the respective layers of polymeric webs used for pouches will in general be selected according to the properties required for the web. However, the blend of the ethylene/vinyl acetate copolymer with the embrittling additive will usually be at least 5 μm thick in order to provide adequate heat seal strengths to the metal foil. However, thicknesses of greater than 25 μm are generally not required as adequate heat seal strengths can usually be achieved with thinner layers. A preferred thickness is about 10 μm.

When a water vapor barrier layer is present as a further outer layer on a core layer, it is preferably from 15 to 45 μm thick. The core layer, for example of a polyolefin, will usually represent the balance of the thickness of such films. The metal foil, which is preferably rolled pressed aluminum foil, will usually have a thickness in the range of from 8 to 40 μm.

In some end uses, it is preferable for the metal foil to be peelable from the polymeric web. However, it is generally not preferred to peel the metal from the metal foil/polymeric web interface because the force required to peel the seals in this manner tends to be difficult to control, and furthermore it would not provide evidence of tampering with the seal. It is therefore particularly preferred for the polymeric webs used in accordance with the present invention to include an intermediate layer between the layer defining the surface which is heat sealed to the metal foil and the core layer. This intermediate layer is preferably such that when the heat seal to the foil is peeled, peeling occurs by splitting through the thickness of the layer sealed to the metal foil, then along the length of the polymeric web within the thickness of the intermediate layer in the region of the heat seal, and thereafter out from within the intermediate layer through to the outer layer of the web if it is not completely heat sealed to the metal foil.

The embrittling additive in the layer heat sealed to the metal foil generally serves to promote breaking through this layer as described above.

Examples of materials which exhibit the above effect described for the intermediate layer are known in the polymeric film art, and they are preferably blends of polyolefins with organic or inorganic fillers. Examples of polyolefins which can be used to form intermediate layers include polyethylenes, for example low density polyethylene, and copolymers of propylene and ethylene. Low density polyethylene and polypropylene are particularly preferred as they have a low elongation at break when compared with other polyolefins, for example polybutene-1 and linear low density polyethylene.

Any of a wide variety of fillers can be used to impart cohesive splitting to the intermediate layer, such fillers serving to reduce the internal cohesive strength of the polymer used to form the layer. Examples of fillers which can be used for the purpose include chalk, talc, titanium dioxide, barium sulfate, magnesium sulfate, polybutene-1, polypropylene and other incompatible polymers.

In addition, the term filler can include a gas which can be introduced using a foaming agent blended into the intermediate layer which foams the intermediate layer at the elevated temperatures to which the polymer is subjected during formation of the polymeric web.

The amount of filler required to reduce the cohesive strength of the intermediate layer so that it will peel by the mechanism described above can be varied within wide limits. However, insufficient filler will result in excessive force being required to peel the seal or even a failure to peel by cohesive rupture within the intermediate layer, but very large amounts of filler can result in an excessive weakening of the intermediate layer. In general, it is preferred that the intermediate layer contains from 15 to 65 wt % of filler and more preferably from 45 to 55 wt %.

As will be appreciated, particulate inorganic fillers in the intermediate layer will usually impart at least some degree of opacity to the films and it may be possible to reduce this opacity by the use of an incompatible polymer in this layer. For example, the addition of polybutene-1 to polyethylene can enable lower amounts of inorganic filler to be used to achieve substantially the same peel strength. More particularly, substantially similar peel strengths can be achieved, but with reduced opacity, by using a blend of 55 wt % of low density polyethylene and 15 wt % of polybutene-1 containing 30 wt % of talc rather than a 50:50 (wt/wt) mixture low density polyethylene and talc.

Changing the polymer of the intermediate layer will often necessitate the use of different incompatible polymers in the intermediate layer.

The thickness of the intermediate layer can in general be varied within wide limits. However, it is generally preferred that it be at least 5 μm thick in order to split effectively when the heat seal is peeled. However, thicknesses of greater than 20 μm are not usually required. It should also be appreciated that when an intermediate layer is present in order to provide a peelable seal, the outer layer to which the metal foil is heat sealed should be of a thickness which facilitates the peeling, and more particularly which facilitates rupture through the thickness of this outer layer so that peeling by cohesive breakdown can occur within the intermediate layer.

As will also be appreciated, peeling of the heat seal between the polymeric web and the metal foil can be arranged to take place by other mechanisms, for example by peeling at the boundary between one polymeric layer and another within the web.

The polymeric webs used in accordance with the present invention can be produced by known methods and preferably by casting melts of the respective polymers through a suitable die, in particular to form substantially flat webs.

Heat sealing of the polymeric web directly to the uncoated surface of a metal foil can be effected in a similar manner to that used hitherto to adhere solvent coated or extrusion laminated metal foils to polymeric webs. However, the conditions under which the heat sealing takes place will in general be selected to obtain the necessary heat seal strength between the polymeric web and the metal foil.

Laminates in accordance with the present invention are preferably in the form of heat sealed packages containing articles. They can be in the form of blister packs, for example as are used for packaging pharmaceutical preparations, or in the form of pouches or sachets.

Embodiments of packages in accordance with the present invention will now be described with reference to the accompanying diagrammatic drawings in which:

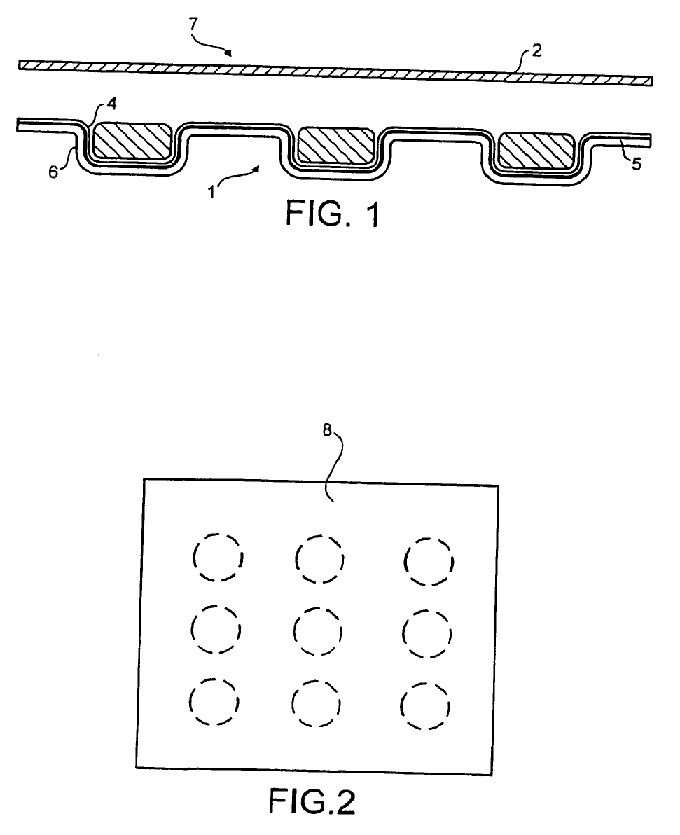

FIG. 1 is a side view of a first embodiment prior to heat sealing;

FIG. 2 is a plan view of the embodiment of FIG. 1 after the completion of heat sealing;

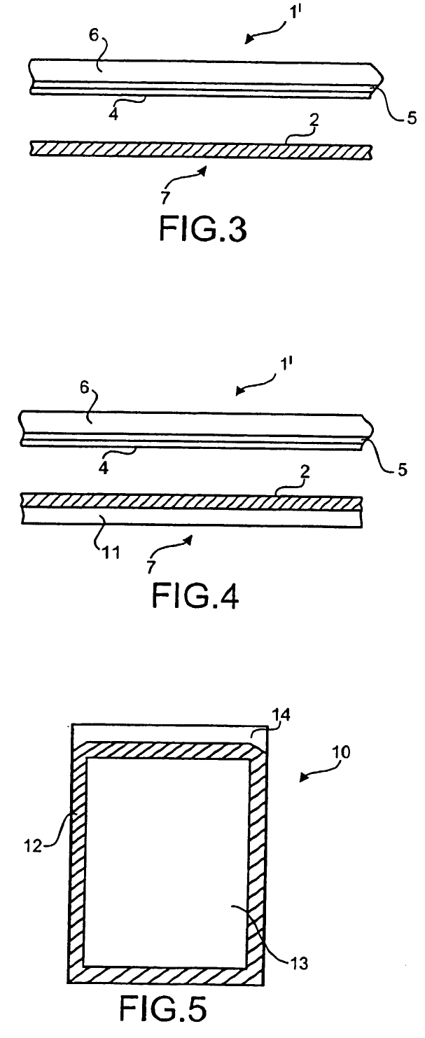

FIG. 3 is side view of a second embodiment prior to heat sealing;

FIG. 4 is a variant of the embodiment of FIG. 3 prior to heat sealing; and

FIG. 5 is a plan view of the embodiment of FIG. 3 and its variant in FIG. 4 after the completion of heat sealing.

FIGS. 1 and 2 show the production of a blister pack in accordance with the present invention from a preformed and shaped polymeric web, shown generally at 1, having a plurality of recesses 3 thermo-formed therein, and a layer of a metal foil 2. The polymeric web 1 consists of three layers, a heat seal layer 4 formed from a blend of an ethylene/vinyl acetate copolymer and an embrittling additive, an intermediate layer 5 formed from a blend of a polyolefin and an additive which reduces its internal cohesion so that peeling of the heat seal which is being formed can occur within the thickness of this layer, and a relatively thick polyolefin substrate layer 6. Heat and pressure applied to the polymeric web 1 and the foil 2 as indicated by the arrow 7 in FIG. 1 result in the formation of the blister pack B.

Tablets (not shown) within the recesses 3 can be pushed out of the recesses 3 by applying sufficient pressure to the polymeric web 1 to cause the tablets to rupture the metal foil 2.

FIGS. 3 to 5 show the production of two forms of substantially identical pouch 10 by heat sealing a polymeric web in the form of a flat but flexible sheet 1′ either to an uncoated metal foil 2 as shown in FIG. 3 or to a metal foil 2 having a supporting polymeric coating 11 on its under side.

In both FIG. 3 and FIG. 4, the web 1′ consists of a heat seal layer 4, an intermediate layer 5 and a support layer 6, the respective layers being formed from substantially similar materials to those used for the web 1 described with reference to FIG. 1.

The polymeric web 1′ is heat sealed to the metal foil 2 in FIG. 3 or to the uncoated metal surface of the coated foil 2 in FIG. 4 by applying pressure in the direction of arrows 7 in FIGS. 3 and 4. The resulting pouch 10 has a peripheral heat seal 12 defining a storage space 13, a tab 14 produced by the web 1′ overlapping the foil 2 but not being heat sealed thereto enabling the heat seal to be peeled opened when desired.

The layer 11 on the metal foil 2 of the pouch formed as in FIG. 4 serves to protect the metal foil against puncturing.

The following Examples are given by way of illustration only.

### EXAMPLE 1

A polymeric film was produced by coextruding through a slot die a base layer formed from three layers of linear low density polyethylene to give a layer with a total thickness of 80 μm, a 10 μm thick intermediate layer of a 50:50 (by weight) blend of talc and low density polyethylene on one surface of the base layer, and a 10 μm thick outer layer of a 60:40 (by weight) blend of an ethylene/vinyl acetate copolymer (18 wt % vinyl acetate) and a hydrogenated hydrocarbon resin as an embrittling additive.

The resulting film, which was 100 μm thick, was laminated to an aluminum foil which was 10 μm thick under a pressure of 500 kPa and at a temperature between 120 and 180° C. The resulting laminate was adhered metal side down to a wheel, and the film was then peeled from the foil by pulling the polymeric web vertically upwardly from the foil. The peel strength of this laminate was 4.0N/15 mm.

### EXAMPLE 2

A five layered polymeric film was produced by coextruding through a slot die a core layer of linear low density polyethylene 40 μm thick with an outer layer of a biaxially oriented polyester web 12 μm thick on one side and adhered thereto by a 2 μm thick polyurethane layer, and on the other side of the core a 5 μm thick intermediate layer of a 50:50 (by weight) blend of talc and low density polyethylene, and a 5 μm thick outer layer of a 60:40 (by weight) blend of an ethylene/vinyl acetate copolymer (9 wt % vinyl acetate) and the hydrogenated hydrocarbon resin used in Example 1.

The film was laminated to a 10 μm thick uncoated aluminum foil as described in Example 1, and the laminate was subjected to a similar peel test. The peel strength observed was 3.3N/15 mm.

### EXAMPLE 3 (Comparison)

A polymeric film was produced substantially as described in Example 2 except that the 60:40 blend of ethylene/vinyl acetate copolymer and hydrocarbon additive was replaced by 100% of the ethylene/vinyl acetate copolymer. The film was then laminated to a 10 μm thick uncoated aluminum foil as described in Example 2, and the peel strength measured as described in Example 1 was 0.5N/15 mm. Peeling was by failure of the heat seal with the heat seal layer of the polymeric web delaminating from the metal foil.

### EXAMPLE 4 (Comparison)

Polymeric films were prepared substantially as described in Examples 1 and 2 except that in each case the seal layer formed from the respective 60:40 blends of ethylene/vinyl acetate copolymers and hydrocarbon additive were replaced by a 60:40 (by weight) blend of low density polyethylene and the hydrocarbon resin.

These films were then laminated to 10 μm thick aluminum foil, and the respective peel strengths of these films to the foil were measured as described in Example 1.

In both cases the peel strengths of these laminates were less than 0.5N/15 mm. Peeling in both cases was by failure of the heat seal with the heat seal layer of the polymeric web delaminating from the metal foil.

1. A laminate comprising a metal foil having an uncoated surface which has been directly heat sealed to the surface of a polymeric web by an outer surface of the web, said outer surface of the web comprising a blend of an ethylene/vinyl acetate copolymer and an additive which embrittles the said copolymer at room temperature.

2. A laminate according to claim 1, wherein the said additive comprises poly-di-pentene or a polyterpene, α-methyl styrene resins, vinyltoluene/α-methyl styrene resins or modified aromatic resins.

3. A laminate according to either of the preceding claims, wherein the said outer surface contains from 5 to 40 wt % of an additive which embrittles the layer.

4. A laminate according to any of the preceding claims, wherein the ethylene/vinyl acetate copolymer contains at least 4.5% by weight of units derived from vinyl acetate.

5. A laminate according to claim 4, wherein the ethylene/vinyl acetate copolymer contains at least 9% by weight of units derived from vinyl acetate.

6. A laminate according to any of the preceding claims, wherein the ethylene/vinyl acetate copolymer contains not more than 30% by weight of units derived from vinyl acetate.

7. A laminate according to any of the preceding claims, wherein the polymeric web has a core layer with one outer layer defining said outer surface on one side thereof, and a further outer layer on the other side of the core layer.

8. A laminate according to claim 7, wherein the core layer comprises a polyolefin.

9. A laminate according to claim 6 or 7, wherein the further outer layer comprises a polyolefin.

10. A laminate according to claim 9, wherein the polyolefin comprises polyethylene.

11. A laminate according to claim 9, wherein the further outer layer comprises polychlorotrifluoroethylene.

12. A laminate according to any of the preceding claims, wherein the polymeric web comprises the outer layer formed from the blend of an ethylene/vinyl acetate copolymer and an additive which embrittles the said copolymer at room temperature, an intermediate layer, and a base layer.

13. A laminate according to claim 10, wherein the intermediate layer comprises a blend of a polyolefin and an incompatible additive which reduces the internal cohesion of the polyolefin.

14. A laminate according to claim 11, wherein the incompatible additive comprises polypropylene, polybutene-1, chalk, talc, titanium dioxide, barium sulfate or magnesium sulfate.

15. A laminate according to any of the preceding claims, wherein the foil has a polymeric coating on the surface not adhered to the polymeric web.

16. A laminate according to claim 1, substantially as herein described.

17. A package comprising a metal foil adhered to a polymeric web, the foil having an uncoated surface directly heat sealed to the surface of the polymeric web by an outer surface of the web, said outer surface of the web comprising a blend of an ethylene/vinyl acetate copolymer and an additive which embrittles the said copolymer at room temperature.

18. A package according to claim 17, wherein the metal foil and the polymeric web are as defined in any of claims 2 to 15.

19. A package according to claim 17 or claim 18, in the form of a blister pack.

20. A package according to claim 17 or claim 18, in the form of a pouch or sachet.

21. A package substantially as herein described with reference to the accompanying drawings.
